(19) United States
(12) Patent Application Publication
(10) Pub. No.: US 2002/0153706 A1
(43) Pub. Date: Oct. 24, 2002

(54) Portable display shelf

(75) Inventors: Christopher F. Yonge, Santa Cruz, CA (US); Michael R. Cabak JR., Aptos, CA (US); Walter M. Poterbin, Santa Cruz, CA (US)

Correspondence Address: Jeffrey Hall, 212 Clinton Street, Santa Cruz, CA, 95062, US

(73) Assignee: Santa Cruz Industries, Inc.

(21) Appl. No.: 09/839,095

(22) Filed: Apr. 19, 2001

(51) Int. Cl. B62B 3/02

(52) U.S. Cl. 280/651

(57) ABSTRACT

A multiple use shelf, for holding, storing, and displaying merchandise, comprising, a first shelf element having a flat portion and a plurality of finger elements. The finger elements being integral with the flat portion of the shelf. The first shelf element is configured and has fastening protrusions for engagement with a support element. A second shelf element, includes a flat portion and a plurality of finger elements. The finger elements being integral with the flat portion and are configured to hingedly join with the finger elements of the first shelf element. The second shelf element is configured and has fastening protrusions for engagement with a support element.

### BACKGROUND OF THE INVENTION

1. Field of Invention

This invention relates to multiple use shelves, and in particular to multiple use shelves with hooked support fingers rotatable for locking and unlocking the shelf in position.

2. Description of the Related Art

Heretofore, numerous shelves have been proposed and implemented for holding, storing and displaying various items. The present invention is an adjustable, multiple use shelf which is particularly useful for merchandising products, and which functions with support elements to form freestanding shelving for various items such as newspapers, folded clothing, food in containers, books, coffee cup, china, boxes, cans, bottles, or bags of merchandise. The applicant is not aware of any similar shelf with such advantages and novel features and function.

Accordingly, the present invention provides a novel multiple use shelf with a plurality of interconnecting fingers which can be made in any width or depth, and which can be modified to carry varying weight loads by adjusting shelf thickness or underlying ribs, or by changing materials from which the shelf is made.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims.

### BRIEF SUMMARY OF THE INVENTION

The present invention is a multiple use shelf, for holding, storing, and displaying merchandise such as newspapers, clothing, food in containers, books, china, boxes, cans, bottles, and the like, comprising, a first shelf element having a flat portion and a plurality of finger elements. The finger elements being integral with the flat portion of the shelf. The first shelf element is configured and has fastening protrusions for engagement with a support element. A second shelf element, includes a flat portion and a plurality of finger elements. The finger elements being integral with the flat portion and are configured to hingedly join with the finger elements of the first shelf element. The second shelf element is configured and has fastening protrusions for engagement with a support element.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows a multiple use shelf, according to the invention.

FIG. 2 shows an example of a support element for such multiple use shelf, according to the invention.

FIG. 3 shows such multiple use shelf and support elements with a wire backing, according to the invention.

FIG. 4 shows an embodiment of such multiple use shelf used for storing and displaying newspapers, according to the invention.

### DETAILED DESCRIPTION OF THE INVENTION

Reference will now be made in detail to the present preferred embodiments of the invention as illustrated in the accompanying drawings.

In accordance with the present invention, there is provided a multiple use shelf, for holding, storing, and displaying merchandise, comprising, a first shelf element having a flat portion and a plurality of finger elements. The finger elements being integral with the flat portion of the shelf. The first shelf element is configured and has fastening protrusions for engagement with a support element. A second shelf element, includes a flat portion and a plurality of finger elements. The finger elements being integral with the flat portion and are configured to hingedly join with the finger elements of the first shelf element. The second shelf element is configured and has fastening protrusions for engagement with a support element.

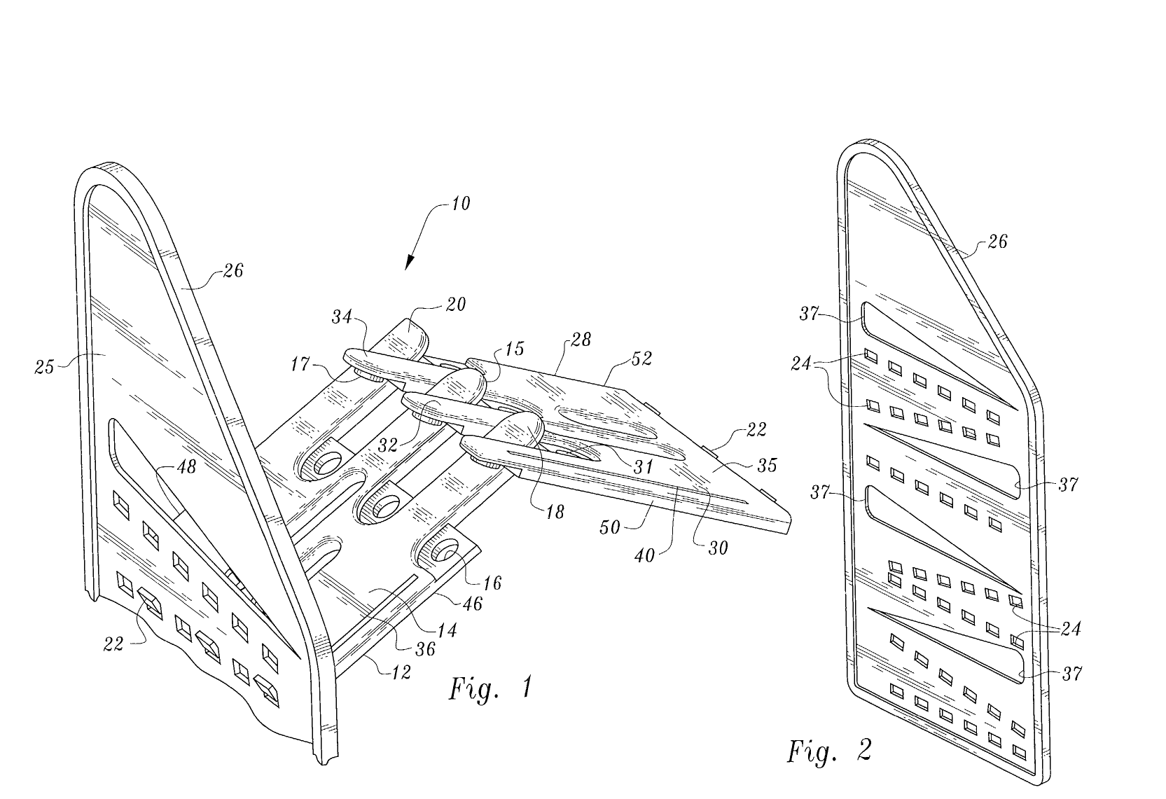

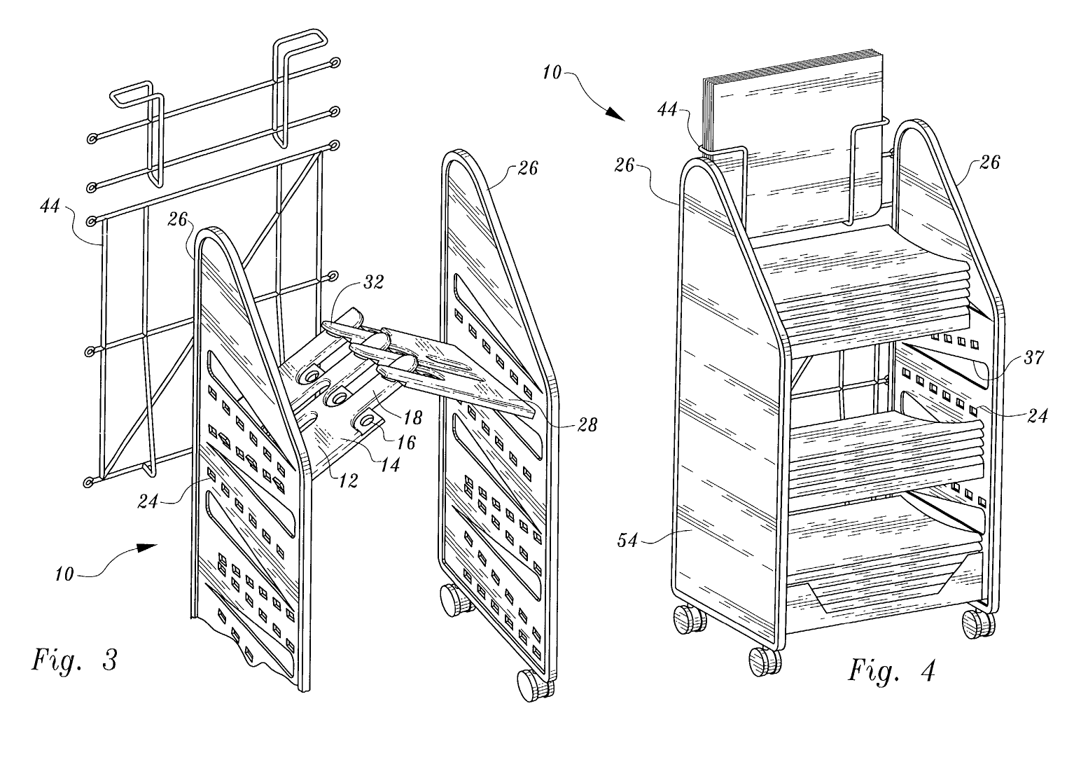

In FIG. 1, a multiple use shelf 10, for holding storing and displaying merchandise, is shown according to a preferred embodiment of the invention. Shelf 10 includes a first shelf element 12, with a flat portion 14 and a plurality of finger elements 18 which may be hooked 20. The finger elements 18, are integral with flat portion 14, and may include small protrusions 17 on the underside for engagement with the second shelf element 28, best seen in FIG. 3. A plurality of receiving depressions 16 are for receiving and securing fingers 32 of second shelf element 28. Preferably, first shelf element 12 has means for engagement with a support element, which may be protrusions 22, to fit in apertures of a support element 26, or flat portion 14 may be configured to fit within a groove or holding fastener of support element 26.

A second shelf element 28 is operably linked to first shelf element 12. The second shelf element 28 preferably has a flat portion 30 and a plurality of finger elements 32. Finger elements 32 may be curved 34. The finger elements 32 are integral with flat portion 30 and are configured to hingedly join with finger elements 18 of first shelf element 12, as seen in FIGS. 1 and 3. A plurality of receiving depressions 31 are for receiving and securing fingers 18 of first shelf element 12. The second shelf element has means for engagement with support element 26, which may be protrusions 22 to fit in apertures of support element 26, or flat portion 30 may be configured to fit within a groove or holding fastener of support element 26. Both first shelf element 12 and second shelf element 28 may be configured with underlying support ribs for added strength.

With reference now to FIG. 2, a support element 26 is shown in one possible configuration. Of course, in use two support elements 26 are used in-between which the first shelf element 12 and the second shelf element 28 are positioned. On first shelf element 12, protrusions 22 are on end 25, which are secured in apertures 24 in support element 26. Similarly, on second shelf element 28, protrusions 22 are on end 35, which are secured in apertures in the second support element 26. In the embodiment illustrated, elongated slots 37 are also shown, and may be desired, for example for use in applications such as newspaper display stands, such as shown in FIG. 4. Alternatively, first shelf element 12 and second shelf element 28 may be fit into grooves, apertures, or recesses in support elements if desired.

First shelf element 12 may have one or more grooves 36 on front edge 46 and back edge 48 for placement of price tags or merchandise identifiers. Similarly, second shelf element 28 may have grooves 36 on front edge 50 and back edge 52 for placement of price tags or merchandise identifiers.

With reference now to FIG. 3, a wire backing element 44 may be used with multiple use shelf 10 for display of merchandise such as newspapers, magazines, or other articles. Wire backing element 44 may be variously configured depending upon the article to be displayed, and is preferably secured to support element 26 by conventional fastening means or configured to slide or snap into position.

In FIG. 4, an example of one use of multiple use shelf 10, where first shelf element 12 and second shelf element 28 are sized and configured with support element 26 as a newspaper display stand 54. Of course, multiple use shelf 10 may be used with a wide variety of other articles such as folded clothing, food in containers, books, china, boxes, cans, bottles or the like.

In operation and use, multiple use shelf 10, can be made to any width or depth, and can be modified to carry varying weight loads by adjusting the shelf thickness or support ribs if used, or by changing materials from which the shelf 10 is made.

Multiple use shelf 10 is best combined with support elements 26 as previously described. Apertures 24 in the support elements allow for the shelf to be raised or lowered according to the hole pattern. Shelves may also be placed in angled positions to aid in merchandise presentation, or for gravity-feed of merchandise toward the front of the shelf. Shelves 10 may also be placed vertically to allow hooks or hangers to be hung from the shelf.

Multiple use shelf 10 may be easily moved from one position to another, without the use of tools. This is a very useful function as product loads may vary, and change from day to day. Positioning of the shelves is limited only by the placement of apertures 24 in support element 26. All that is needed to install shelf 10 is first shelf element 12 and second shelf element 28 with accompanying support elements 26.

As the shelf rotates into position while sitting on support fingers 18 and 32, the fingers lock the sides securely to the shelf. If one side is pulled then the shelf and opposite side move as a unit, this prevents the shelf from becoming disengaged from the sides, and falling out of position.

As the support elements 26 may be provided as symmetrical units, additional columns of shelves can be added to the first column. After the first shelf and two sides are in place, additional columns require only a shelf and one additional side, and can be added to the left or to the right of the original column. Accordingly, rows of shelf-columns can be made as long as necessary.

The front and back edges of both the first shelf element 12 and the second shelf element 28, preferably have grooves 36 and 40 respectively, to allow various price tag-holders, or merchandise identifiers, to be fastened into position. These grooves can also support restraining fences for preventing merchandise from falling off the shelf. The grooves also allow these various devices to be snapped into position without the use of tools or secondary fasteners. Such attachment devices, such as tag molding, may also act as security against the accidental “folding up” of the shelves, as they preferably span both halves of the shelf. Further, if the support elements 26 are fitted with casters, the shelf columns become portable, as seen in FIG. 4, and can be rolled from one position in the store to another, either as single-column units or as multiple-column units.

As is evident from the above description, a wide variety of shelves may been envisioned from the shelf described herein and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A multiple use shelf, comprising:
a first shelf element, said first shelf element having a flat portion and a plurality of finger elements, said finger elements being integral with said flat portion; said first shelf element having means for engagement with a support element; and
a second shelf element, said second shelf element having a flat portion and a plurality of finger elements, said finger elements being integral with said flat portion and being configured to hingedly join with said finger elements of said first shelf element, said second shelf element having means for engagement with a support element.

2. The multiple use shelf of claim 1, wherein said first shelf element has a plurality of depressions for receiving and securing said fingers of said second shelf element

3. The multiple use shelf of claim 1, wherein said second shelf element has a plurality of depressions for receiving and securing said fingers of said first shelf element

4. The multiple use shelf of claim 1, wherein said fingers of said first shelf element are curved.

5. The multiple use shelf of claim 1, wherein said fingers of said second shelf element are curved.

6. The multiple use shelf of claim 1, wherein said means for engagement with a support element of said first shelf element comprises a plurality of protrusions for securing said first shelf element to a support element.

7. The multiple use shelf of claim 1, wherein said means for engagement with a support element of said second shelf element comprises a plurality of protrusions for securing said first shelf element to a support element.

8. The multiple use shelf of claim 1, wherein said first shelf element has one or more grooves on two sides thereof.

9. The multiple use shelf of claim 1, wherein said second shelf element has one or more grooves on two sides thereof.

10. The multiple use shelf of claim 1, further including a wire backing element.

11. The multiple use shelf of claim 1, wherein said first shelf element, said second shelf element, and said support elements are configured as a newspaper display stand.
